(19) United States
(12) Patent Application Publication
(10) Pub. No.: US 2007/0084930 A1
(43) Pub. Date: Apr. 19, 2007

(54) Barcode reader with a permanent storage

(76) Inventors: Hitoshi Watanabe, Saitamai-shi (JP); Hironobu Watanabe, Koshigaya-shi (JP)

Correspondence Address: KAPLAN GILMAN GIBSON & DERNIER L.L.P., 900 ROUTE 9 NORTH, WOODBRIDGE, NJ, 07095, US

(21) Appl. No.: 11/253,109

(22) Filed: Oct. 18, 2005

(51) Int. Cl. G06K 7/10

(52) U.S. Cl. 235/462.13; 235/462.45

(57) ABSTRACT

A portable barcode reader is provided, which comprises a permanent storage for storing data obtained from reading barcodes. Preferably, the permanent storage is a USB Mass Storage, and a USB connector is connected to a body of the barcode reader for transmitting the data saved in the storage to an external device such as a computer for display or for further processing after scanning operations. No data transmission cable is needed to keep the barcode reader with the computer during the scanning operations.

### BACKGROUND OF THE INVENTION

The present invention relates to a symbol reader, and more particularly, to a portable barcode reader integrated with a permanent storage for saving data obtained from reading barcodes.

As illustrated in FIG. 1, conventionally a handheld barcode reader 100 is connected to a host computer 101 through a data transmission cable 102 so that the data obtained from reading barcodes is instantly transmitted to the host computer 101 for display and for further processing during a barcode reading operation. This is inconvenient since the handheld barcode reader 100 has to be connected to the computer 101 during the barcode reading operation.

Therefore, there is a need for a portable barcode reader that does not need to be connected to an external unit such as a host computer during a barcode reading operation.

### SUMMARY OF THE INVENTION

To realize the above object, a barcode reader according to the present invention comprises a permanent storage for storing data obtained from reading barcodes. Thus, the data obtained during a barcode reading operation does not need to be instantly transmitted to an external unit such as a host computer, instead the data can be saved in the permanent storage integrated in the barcode reader and transmitted to an external unit at a later time, if needed. Thus, the barcode reader does not need to be connected to a host computer during the reading operation.

In a preferred embodiment, the permanent storage is a USB Mass Storage. Preferably, a USB connector is permanently secured to a body of the barcode reader. Preferably, the USB connector is pivotally connected to the body of the barcode reader such that it can be rotated toward the body of the barcode reader. Preferably, the body of the barcode reader is provided with a recess for snugly accommodating the USB connector after it is rotated to the body of the barcode reader.

Preferably, the barcode reader is provided with a clip adapted to attach the barcode reader to an external item such as a pocket.

Preferably, the barcode reader comprises a display for showing human recognizable information, such as information decoded from the read barcodes and instructions on how to use the barcode reader.

### BRIEF EXPLANATIONS OF THE DRAWINGS

The above and other features and advantages will be clearer after reading the detailed description of the preferred embodiments of the present invention with reference to the accompanying drawings, in which:

FIG. 1 schematically illustrates a conventional portable barcode reader in the prior art;

FIG. 2a is a front view schematically illustrating an embodiment of the barcode reader according to the present invention;

FIG. 2b is a back view of the embodiment in FIG. 2a;

FIG. 2c is a back view similar to FIG. 2a, but with the USB connector rest in a recess of a body of the barcode reader;

FIG. 2d is a side view of the embodiment in FIG. 2a;

FIG. 3 is a front view similar to FIG. 2a schematically illustrating another embodiment of the barcode reader according to the present invention.

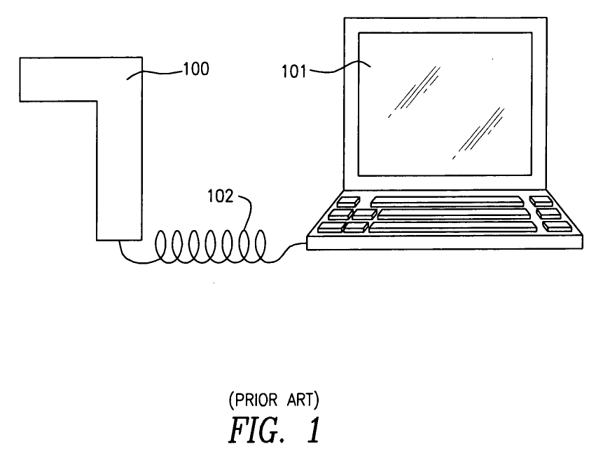

### DETAILED DESCRIPTION OF THE INVENTION

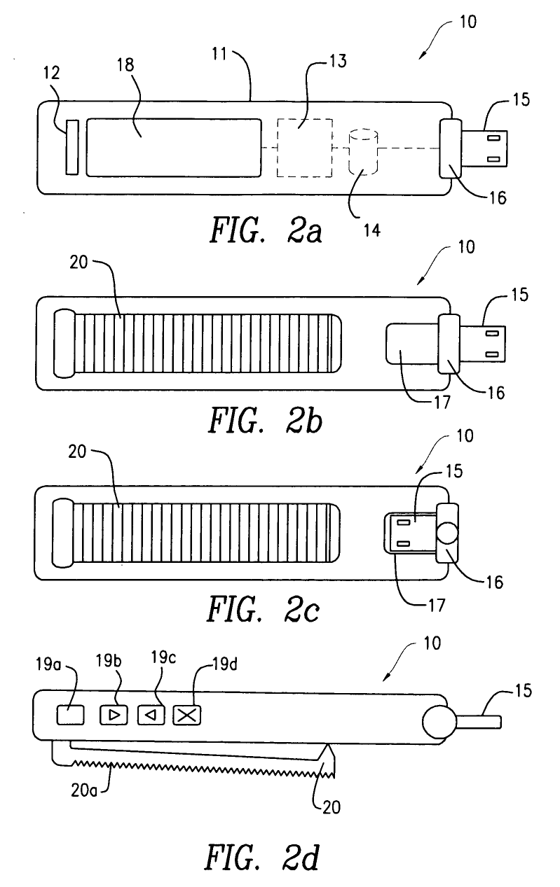

FIGS. 2a-2d schematically illustrates an embodiment of a portable or handheld barcode reader 10 according to the present invention. The barcode reader has a generally elongated body 11, which houses components of barcode reading and processing units and circuitries, as generally represented by a block 13. A slot 12 is provided in the front surface of the body 111 for projecting a scan light beam and for receiving reflected light during a scanning operation. A slot 12 can be positioned at the tip of the elongated body at the opposite of USB connector.

According to the teaching of the present invention, a permanent storage 14 is provided as a component of the barcode reader 10. The permanent storage 14 works to save data obtained in barcode reading operations. Preferably, the data saved in the storage 14 comprises information already decoded from barcodes read into the barcode reader. In addition or alternatively, the data saved in the storage 14 may comprise “raw” data that represents the barcodes read into the reader but has not been decoded yet and may need to be decoded by a host computer.

With the permanent storage 14 provided in the barcode reader 10, the data can be saved in the permanent storage 14 and does not need to be instantly transmitted to a host computer as in the prior art for display or for further processing. Therefore, no data transmission cable is needed to connect the handheld barcode reader 10 with the host computer or other external unit during the barcode reading operations.

If the data saved in the storage 14 needs to be transmitted to an external unit such as a computer, the barcode reader 10 can be connected to the computer by a data transmission cable (not shown) at a later time after the scanning operations. Alternatively, the permanent storage 14 (such as a memory stick or a memory card) can be removed from the barcode reader 10 and presented to a proper reading device of the computer.

Preferably, the permanent storage 14 is a USB Mass Storage device (e.g., a flash memory), and a USB connector 15 is provided at an end of the elongated body 11 of the barcode reader 10, as illustrated in FIG. 2a-2d. To transmit the data saved in the USB Mass Storage 14 to a computer, a user can conveniently insert the USB connector 15 to a USB slot of the computer. This eliminates the need of a data transmission cable for data transmission between the barcode reader 10 and the computer. In addition, if the computer runs a Windows operating system, no driver needs to be installed in the computer for recognizing the USB Mass Storage 14.

Preferably, the USB connector 15 is permanently connected to the end of the body 11 by a pivotal connection 16 such that the USB connector 15 can be rotated toward the body 11 to snugly rest in a recess 17 provided in a back surface of the body 11, as best seen in FIGS. 2b and 2c. This helps to prevent the USB connector 15 from inadvertent damage.

Preferably, a display, such as an LCD display 18, is provided on the front surface of the body 11 of the barcode reader 11. The display 18 may show human recognizable information saved in permanent storage 14, such as the information decoded from the read barcodes or the instructions on how to use the barcode reader 10.

Several operational buttons 19a-19d may be provided, e.g., on a narrow top surface of the barcode reader 11, as illustrated in FIG. 2d. These buttons may include an activation button 19a to trigger a scanning operation, forward and backward buttons 19b, 19c for browsing the information shown on the display 18, a cancellation button 19d for deleting data obtained in a unsatisfactory scanning operation or some undesirable information from the storage 14.

Preferably, a surface of the display 18 is properly processed to be usable as a cosmetic mirror as well.

Preferably, the barcode reader 11 is provided with a clip 20 adapted to conveniently attach the barcode reader 10 to an external item, e.g., a pocket of a shirt of the user.

Preferably, the clip has a corrugated surface 20a to provide a solid feeling when the user holds the barcode reader 10.

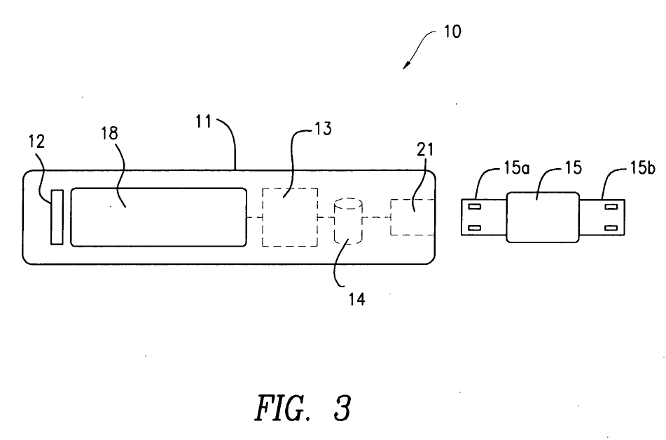

FIG. 3 illustrates another embodiment of the barcode reader 10 according to the present invention. This embodiment is different from that illustrated in FIGS. 2a-2d in that the USB connector 15 is not permanently connected to the body 11 of the barcode reader 10. Instead, the USB connector 15 can be removably inserted to a USB port 21 provided at an end of the body 111 in communication with the permanent storage 14, which is preferably a USB Mass Storage. More specifically, the USB connector 15 comprises a first connection end 15a for connecting the USB connector 15 to the USP port 21 of the barcode reader 10, and a second connection end 15b for connecting to a USB port of a computer (not shown).

Though the above has described the preferred embodiments of the present invention, it shall be understood that numerous adaptations, modifications and variations are possible to those skilled in the art without departing the gist of the present invention. For example, the USB port 21 in FIG. 3 may be replaced with a parallel port for transmitting data from the permanent storage 14 to a host computer through a data transmission cable. The LCD display 18 may show other information interesting to or saved by the user, such as contacts or other personal information. Therefore, the scope of the present invention is solely intended to be defined by the accompanying claims.

1. A barcode reader, comprising a permanent storage for storing data obtained from reading barcodes.

2. The barcode reader of claim 1, further comprising a port for transporting said data in said storage to an external unit.

3. The barcode reader of claim 2, wherein said external unit is a computer.

4. The barcode reader of claim 2, wherein said permanent storage is a USB Mass Storage.

5. The barcode reader of claim 4, wherein said port is a USB port.

6. The barcode reader of claim 5, further comprising a USB connector permanently connected to said USB port.

7. The barcode reader of claim 6, wherein said USB connector is connected to an end of a body of said barcode reader.

8. The barcode reader of claim 7, wherein said USB connector is pivotally connected to said end such that said USB connector is foldable toward said body.

9. The barcode reader of claim 8, wherein said body is formed with a recess adapted to snugly accommodate said USB connector when said USB connector is folded to said body.

10. The barcode reader of claim 7, wherein said body has an elongate configuration.

11. The barcode reader of claim 10, further comprising a clip provided at an end of said body, said clip being adapted to attach said barcode reader to an external item.

12. The barcode reader of claim 11, wherein said end at which said clip is provided is opposite to said end to which said USB is connected.

13. The barcode reader of claim 1, wherein said storage unit is a flash memory.

14. The barcode reader of claim 1, further comprising a display for showing human recognizable information.

15. The barcode reader of claim 14, wherein said human recognizable information comprises information decoded from said barcodes.

16. The barcode reader of claim 14, wherein said human recognizable information comprises instructions for using said barcode reader.

17. The barcode reader of claim 14, wherein said display is an LCD.

18. The barcode reader of claim 14, further comprising buttons for browsing through said human recognizable information.

19. The barcode reader of claim 14, further comprising buttons for canceling at least some of said human recognizable information.

20. The barcode reader of claim 14, wherein a surface of said display is adapted to work as a cosmetic mirror.

21. A barcode reader comprising a body and a permanent storage housed inside said body for saving data obtained from reading barcodes.

22. The barcode reader of claim 21, wherein said permanent storage is a USB Mass Storage.

23. The barcode reader of claim 22, further comprising a USB port for transmitting said data in said storage unit to an external unit.

24. The barcode of claim 23, wherein said body has an elongate configuration with first and second ends opposite to each other.

25. The barcode reader of claim 24, further comprising a USB connector in communications with said USB port, wherein said USB connector is permanently connected to said first end of said body.

26. The barcode reader of claim 25, wherein said USB connector is pivotally connected to said first end and is foldable into a recess formed in said body.

27. The barcode reader of claim 26, further comprising a clip provided at said second end of said body and extending from said second end toward said first end, said clip being adapted to attach said barcode reader to an external item.

28. The barcode reader of claim 25, further comprising a display for showing information decoded from said barcodes.
